(19) United States
(12) Patent Application Publication
(10) Pub. No.: US 2023/0355075 A1
(43) Pub. Date: Nov. 9, 2023

(54) SOAP DISPENSING DISH WAND HOLDER ASSEMBLY

(71) Applicant: Scott Benedict, Melbourne, FL (US)

(72) Inventor: Scott Benedict, Melbourne, FL (US)

(21) Appl. No.: 17/662,424

(22) Filed: May 7, 2022

(51) Int. Cl. A47L 17/00; F16M 13/02

(52) U.S. Cl. CPC A47L 17/00; F16M 13/02; A47K 5/12

(57) ABSTRACT

A soap dispensing wand holder assembly for holding a soap wand in a vertical orientation for storage that can be placed on any flat surface. A soap dispensing wand holder assembly which also has an opening for insertion and holding of a sponge or other implement. Said holder assembly which is composed of plastic, metal, bamboo, wood, or other suitable materials or combinations of materials. Said holder assembly which is watertight to protect any surface the holder assembly is sitting upon.

### TECHNICAL FIELD

The present invention relates generally to the field of holder devices and more specifically for holders of soap dispensing dish wands.

### BACKGROUND

The following is a tabulation of some prior art that presently appears relevant:

U.S. Patents

| U.S. Pat. No. | Kind Code | Issue Date | Patentee |
|---|---|---|---|
| U.S. Pat. No. 7,438,271 | B1 | Oct. 21, 2008 | Iannace |
| U.S. Pat. No. 9,220,391 | B1 | Dec. 29, 2015 | Henninger |
| U.S. Pat. No. 10,883,654 | B2 | Jan. 5, 2021 | Dougherty |

Soap dispensing wands must be stored in an upright position so that liquid soap does not run out. Existing holders for soap dispensing wands are deficient with regard to several aspects. For instance, currently available holders are for sponges in general and do not adequately support soap dispensing dish wands. Of the holders that support soap dispensing dish wands in an upright position, currently available holders must be attached to the sink and drain into the sink. Current holders of soap dispensing dish wands do not stand alone. Many current soap dispensing dish wand holders do not protect the surface that they sit on. Therefore, there is a need for an improved holder assembly for soap dispensing dish wands that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

This invention is for a soap dispensing dish wand holder assembly that holds a soap dispensing dish wand in an upright position to prevent soap from leaking out during storage. Optionally, the soap dispensing dish wand holder assembly may hold a sponge or other implement. The soap dispensing dish wand holder assembly may be made watertight to protect surfaces that the holder assembly is sitting on. The holder assembly may be placed on any flat surface and does not require mounting of any kind. The soap dispensing dish wand holder assembly may be made of plastic, bamboo, metal, wood, or other suitable material or combination of materials. The supporting members of the holder assembly may be attached by glue, welding, or any other joinery techniques that are suitable for the material that the holder assembly is composed of.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### ADVANTAGES

Accordingly several advantages of one or more aspects are as follows: the present invention holds a soap dispensing dish wand in an upright position so that any liquid soap in the soap dispensing dish wand does not leak out. The holder assembly may be placed on any flat surface and is not limited to being attached to a sink or counter as in the prior art. The holder assembly may optionally hold a sponge or other implement. The holder assembly may be manufactured so that it holds in any liquid from the sponge or other implement or from the soap dispensing dish wand.

### BRIEF DESCRIPTION OF THE DRAWINGS

The accompanying drawings, which are incorporated in and constitute a part of this disclosure, illustrate various embodiments of the present disclosure. Furthermore, the drawings may contain text or captions that may explain certain embodiments of the present disclosure. This text is included for illustrative, non-limiting, explanatory purposes of certain embodiments detailed in the present disclosure.

FIG. 1 generally shows a front perspective view of a soap dispensing wand holder assembly where at least one side is made of a clear material.

FIG. 2 generally shows a side and front perspective view of a soap dispensing wand holder assembly holding a soap dispensing wand and a sponge where at least one side is made of a clear material.

FIG. 3 generally shows a back and side perspective view of a soap dispensing wand holder assembly holding a soap dispensing wand and a sponge.

FIG. 4 generally shows a front view of a soap dispensing wand holder assembly.

FIG. 5 generally shows a back view of a soap dispensing wand holder assembly.

FIG. 6 generally shows a side view of a soap dispensing wand holder assembly in which one side is made of a clear material.

FIG. 7 generally shows a perspective view of an alternative embodiment of a soap dispensing wand holder assembly in which one side is made of a clear material.

FIG. 8 generally shows a perspective view of an alternative embodiment of a soap dispensing wand holder assembly in which one side is made of a clear material and an opening is sufficient to hold a refill for the soap dispensing wand holder assembly.

FIG. 9 generally shows a back view of an alternative embodiment of a soap dispensing wand holder assembly.

FIG. 10 generally shows a front view of an alternative embodiment of a soap dispensing wand holder assembly.

FIG. 11 generally shows a side view of an alternative embodiment of a soap dispensing wand holder assembly.

### DETAILED DESCRIPTION

As a preliminary matter, it will be readily understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure.

Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

While embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

It is intended that the scope of patent protection is to be defined by the issued claim(s) rather than the description set forth herein. Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While multiple embodiments of the disclosure may be described, modifications, adaptations, and other implementations are possible. For example, substitutions, additions, or modifications may be made to the elements illustrated in the drawings. Accordingly, the following detailed description does not limit the disclosure. Instead, the proper scope of the disclosure is defined by the appended claims.

Throughout this disclosure, the term attached may mean put together by use of glue, welding, or any other joinery that would be appropriate for the material or combinations of materials that a soap dispensing wand holder assembly is made of. A soap dispensing wand holder assembly may be manufactured of plastic, rubberized material, bamboo, wood, metal, or any other material or combinations of materials. A soap dispensing wand holder assembly may also be manufactured of a clear plastic or other material.

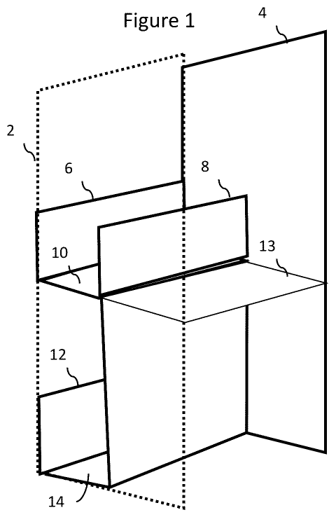

FIG. 1 generally shows a side and front perspective view of a soap dispensing wand holder assembly. In FIG. 1, side 2 is shown as manufactured of a clear material so that the inner components of a soap dispensing wand holder assembly may be viewed. This is not intended to limit the materials used in the holder assembly and the holder assembly may be manufactured of any suitable material or combinations of materials whether clear or opaque. Side 4 is parallel to side 2. Supporting member 8 is vertically attached to both sides 2 and 4. Supporting member 10 is horizontally attached to supporting member 8 and sides 2 and 4. Supporting member 6 is vertically attached to supporting member 10 and sides 2 and 4. Supporting member 14 is horizontally attached to the bottom edge of supporting member 8 and sides 2 and 4. Supporting member 12 is attached vertically to supporting member 14 and sides 2 and 4. Supporting member 13 is attached horizontally to supporting member 8 and sides 2 and 4.

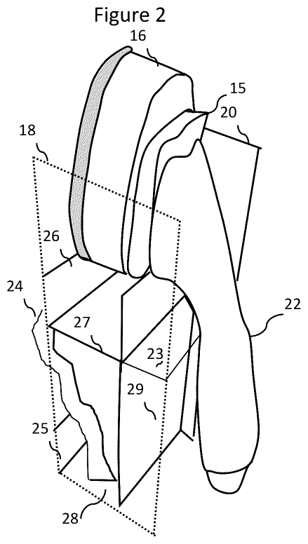

FIG. 2 generally shows a side perspective view of a soap dispensing wand holder assembly as in use with a soap dispensing wand 15 and a sponge 24. Side 18 is shown as made of a clear material so that the inner workings of the holder assembly may be viewed. This is not intended to limit the materials used in the holder assembly and the holder assembly may be manufactured of any suitable material or combination of materials whether clear or opaque. A soap dispensing wand 15 is composed of a wand 22 which contains liquid soap and a sponge 16 which dispenses the soap. The sponge 16 may alternatively be a brush or other implement. Side 20 is parallel to side 18. Supporting member 29 is attached vertically to sides 20 and 18. Alternatively, supporting member 27 may be attached in a watertight manner in order to contain any liquid released by the sponge 16. Supporting member 27 is attached horizontally to sides 18 and 20 and supporting member 29. Supporting member 26 is attached vertically to sides 18 and 20 and supporting member 27. Supporting member 28 is attached horizontally to supporting member 29 and sides 18 and 20. Supporting member 28 is attached in a watertight manner in order to contain any liquid released by sponge 24. Supporting member 25 is attached vertically to supporting member 28 and sides 18 and 20. Supporting member 23 is attached horizontally to supporting member 29 and sides 18 and 20.

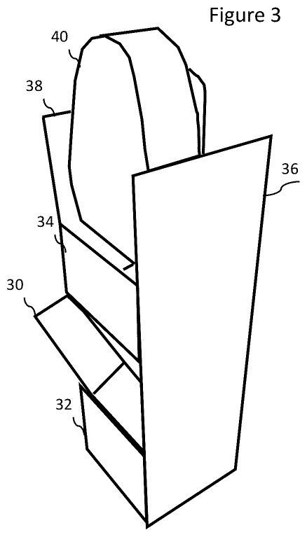

FIG. 3 generally shows a back and side perspective view of a soap dispensing wand holder assembly in use. In this view, the holder assembly is constructed of an opaque material, but this is not meant to limit the construction of the holder assembly to any specific material. Sides 36 and 38 are parallel to each other. Supporting member 34 is vertically attached to sides 36 and 38. Supporting member 32 is vertically attached to sides 36 and 38. Sponge 30 is inserted into the opening between supporting member 32 and supporting member 34. Soap dispensing wand 40 is inserted into the top of the holder assembly and is supported by supporting members not shown. Soap dispensing wand is shown as being comprised of a sponge, but could also be comprised of a brush or other implement.

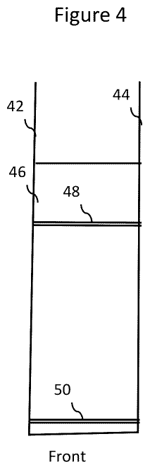

FIG. 4 generally shows a front view of a soap dispensing wand holder assembly. Sides 42 and 44 are parallel to each other. Supporting member 46 is connected vertically to sides 42 and 44. Supporting member 48 is connected horizontally to sides 42 and 44 and supporting member 46. Supporting member 50 is connected horizontally to sides 42 and 44.

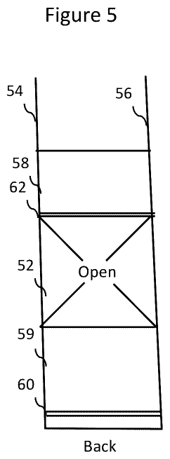

FIG. 5 generally shows a back view of a soap dispensing wand holder assembly. Sides 54 and 56 are parallel to each other. Supporting member 58 is attached vertically to sides 54 and 56. Supporting member 62 is attached horizontally to sides 54 and 56 and supporting member 58. Supporting member 59 is attached vertically to sides 54 and 56. Supporting member 60 is attached vertically to sides 54 and 56 and supporting member 59. An opening 52 is a discrete and optional opening where a sponge or other implement may be inserted.

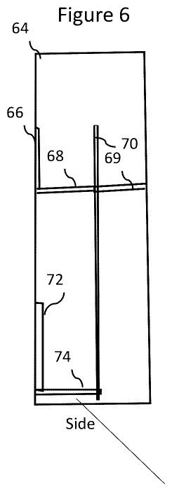

FIG. 6 generally shows a side view of a soap dispensing wand holder assembly. Side 64 is shown as a clear material, but this is not intended to limit the construction of the holder assembly to any specific material. Supporting member 70 is attached vertically to side 64. Supporting member 68 is attached horizontally to supporting member 70 and side 64. Supporting member 66 is attached vertically to supporting member 68 and side 64. Supporting member 74 is attached horizontally to supporting member 70 and side 64. Supporting member 72 is attached vertically to supporting member 74 and side 64. Supporting member 69 is attached horizontally to supporting member 70 and side 64.

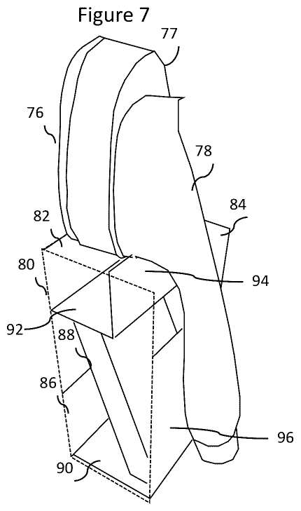

FIG. 7 generally shows a perspective view of an alternative embodiment of a soap dispensing wand holder assembly. Side 80 is shown as a clear material, but this is not intended to limit the construction of the holder assembly. The holder assembly is shown holding a soap dispensing wand 76 which could be of any type. The soap dispensing wand consists of a sponge 77 or a brush connected to a wand 78. Side 84 is parallel to side 80. Supporting member 94 is attached vertically to sides 80 and 84. Supporting member 92 is attached horizontally to supporting member 94 and sides 80 and 84. Supporting member 82 is attached vertically to supporting member 92 and sides 80 and 84. Supporting member 96 is attached vertically to sides 80 and 84. Supporting member 90 is connected horizontally to supporting member 96 and sides 80 and 84. Supporting member 86 is attached vertically to supporting member 90 and sides 80 and 84 in such a way that a sponge 88 may be supported.

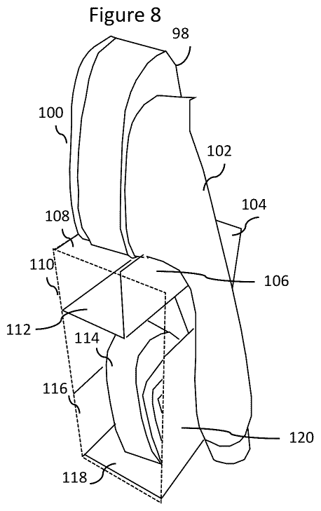

FIG. 8 generally shows a perspective view of an alternative embodiment of a soap dispensing wand holder assembly. Side 110 is shown as a clear material, but this is not intended to limit the construction of the holder assembly. The holder assembly is shown holding a soap dispensing wand 100 which could be of any type. The soap dispensing wand consists of a sponge 98 or a brush connected to a wand 102. Side 104 is parallel to side 110. Supporting member 106 is attached vertically to sides 110 and 104. Supporting member 112 is attached horizontally to supporting member 112 and sides 110 and 104. Supporting member 108 is attached vertically to supporting member 112 and sides 110 and 104. Supporting member 120 is attached vertically to sides 110 and 104. Supporting member 118 is connected horizontally to supporting member 120 and sides 110 and 104. Supporting member 116 is attached vertically to supporting member 118 and sides 110 and 104 in such a way that a refill 114 for the soap dispensing wand 100 may be supported.

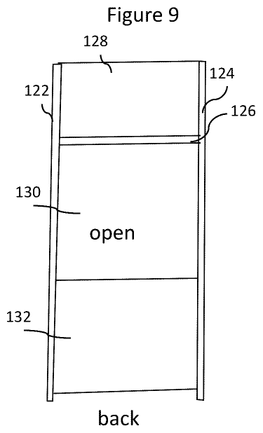

FIG. 9 generally shows a back view of an alternative embodiment of a soap dispensing wand holder assembly. Side 122 is parallel to side 124. Supporting member 128 is attached vertically to sides 122 and 124. Supporting member 126 is attached horizontally to supporting member 128 and sides 122 and 124. Supporting member 132 is attached vertically to sides 122 and 124, leaving an area open 130.

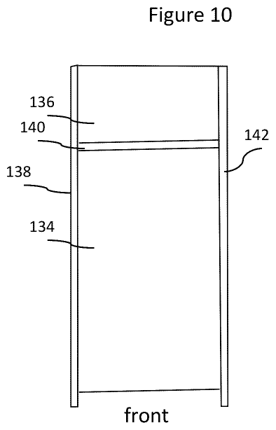

FIG. 10 generally shows a front view of an alternative embodiment of a soap dispensing wand holder assembly. Sides 138 and 142 are parallel to each other. Supporting member 136 is attached vertically to sides 138 and 142. Supporting member 140 is attached to supporting member 136 and sides 138 and 142. Supporting member 134 is attached to sides 138 and 142.

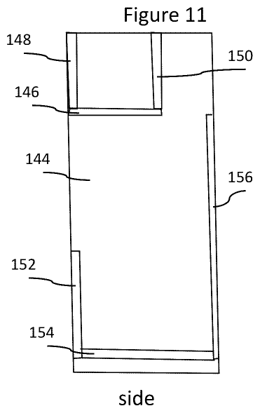

FIG. 11 generally shows a side view of an alternative embodiment of a soap dispensing wand holder assembly. Side 144 is shown in FIG. 11 as a clear material but this is not intended to limit any choice of materials for the holder assembly. Supporting member 148 is attached vertically to side 144. Supporting member 146 is attached horizontally to supporting member 148 and side 144. Supporting member 150 is attached vertically to supporting member 146 and side 144. Supporting member 152 is attached vertically to side 144. Supporting member 154 is attached horizontally to supporting member 152 and side 144. Supporting member 156 is attached vertically to supporting member 154 and side 144.

Although there have been shown and described the preferred embodiments of the present invention, it will be readily apparent to those skilled in the art that modifications may be made thereto which do not exceed the scope of the appended claims. Therefore, the scope of the invention is only to be limited by the following claims.

I claim:

1. A soap dispensing wand holder assembly used to store a soap dispensing wand in an upright position, the soap dispensing wand holder assembly consisting of at least two parallel side members, and a plurality of supporting members arranged both vertically and horizontally in such a way so that a soap dispensing wand or other implement can be held in an upright position and furthermore the plurality of supporting members is also arranged vertically and horizontally so that the soap dispensing wand holder assembly can be placed in an upright manner on any flat surface.

2. The soap dispensing wand holder assembly of claim 1 wherein at least one supporting member is attached vertically to the at least two parallel side members in such a way that the at least one supporting member could support at least a top part of a soap dispensing wand or other implement.

3. The soap dispensing wand holder assembly of claim 1 wherein a plurality of supporting members is attached in such a manner that the holder assembly is watertight.

4. The soap dispensing wand holder assembly of claim 1 wherein at least one of the plurality of supporting members is attached vertically in such a manner as to leave a discrete opening in which an additional sponge or other implement can be inserted for storage.

5. The soap dispensing wand holder assembly of claim 1 wherein the soap dispensing wand holder assembly is composed of plastic, bamboo, metal, wood, or other suitable material or combinations of materials.

6. The soap dispensing wand holder of claim 1 wherein the sides and plurality of supporting members are joined by glue, welding, or any other joinery techniques suitable for the material or combinations of materials that the soap dispensing wand holder assembly is composed of.
